(19) United States
(12) Patent Application Publication
(10) Pub. No.: US 2013/0054334 A1
(43) Pub. Date: Feb. 28, 2013

(54) MONITORING OF ACTIVITY TO MITIGATE ACCOUNT ATTRITION

(71) Applicants: Erik Stephen Ross, Charlotte, NC (US); Stephen F. Gugerty, Newark, DE (US)

(72) Inventors: Erik Stephen Ross, Charlotte, NC (US); Stephen F. Gugerty, Newark, DE (US)

(73) Assignee: BANK OF AMERICA, Charlotte, NC (US)

(21) Appl. No.: 13/219,190

(22) Filed: Aug. 26, 2011

(51) Int. Cl. G06Q 30/00

(52) U.S. Cl. 705/14.25

(57) ABSTRACT

Apparatuses, computer readable media, methods, and systems are described for identifying a change or an increased likelihood of a change in a usage pattern of an account, generating an offer in response to the identifying, the offer comprising an incentive for use of the account in future transactions, and causing transmission of the offer.

### BACKGROUND

A credit card issuer, such as a bank or credit union, may approve an account for a customer and issue a credit card to the customer. Customers may make purchases at retailers or other merchants accepting that card. When a purchase is made, the customer agrees to pay the card issuer for the amount charged. Merchants may use electronic verification systems to confirm that the card is valid and that the customer has sufficient credit. Each month, the issuer may send the customer a statement listing the purchases made with the card, and the amount owed. The customer may pay a minimum amount up to the entire balance by a due date. Interest may be assessed on the amount owed if not paid in full.

Credit card companies often provide incentives for their customers to continue using a credit card, for balance transfers and/or for cash advances. Incentives can include rewards such as frequent flyer points, gift certificates, or cash back. Credit card companies earn fees on each transaction with a retailer or other type of merchant, and may use a portion of these fees to provide the incentives. A credit card company may provide a product or cash reward when a customer has made purchases using the card.

### BRIEF SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

According to aspects of example embodiments, apparatuses, computer readable media, methods, and systems are described for identifying a change or an increased likelihood of a change in a usage pattern of an account, generating an offer in response to the identifying, the offer comprising an incentive for use of the account in future transactions, and causing transmission of the offer.

Aspects of the embodiments may be provided in at least one computer-readable medium and/or memory storing computer-executable instructions that, when executed by at least one processor, cause a computer or other apparatus to perform one or more of the process steps described herein.

These and other aspects of the embodiments are discussed in greater detail throughout this disclosure, including the accompanying drawings.

### BRIEF DESCRIPTION OF THE DRAWINGS

The present disclosure is illustrated by way of example and not limited in the accompanying figures in which like reference numerals indicate similar elements and in which:

FIG. 1 shows an illustrative operating environment in which various aspects of the disclosures may be implemented in accordance with example embodiments.

FIG. 2 is an illustrative block diagram of workstations and servers that may be used to implement the processes and functions of certain aspects of the present disclosure in accordance with example embodiments.

FIG. 3 illustrates an example flow diagram of a method for monitoring of activity to mitigate account attrition.

### DETAILED DESCRIPTION

In the following description of the various embodiments, reference is made to the accompanying drawings, which form a part hereof, and in which is shown by way of illustration various embodiments in which the disclosure may be practiced. It is to be understood that other embodiments may be utilized and structural and functional modifications may be made without departing from the scope and spirit of the present disclosure.

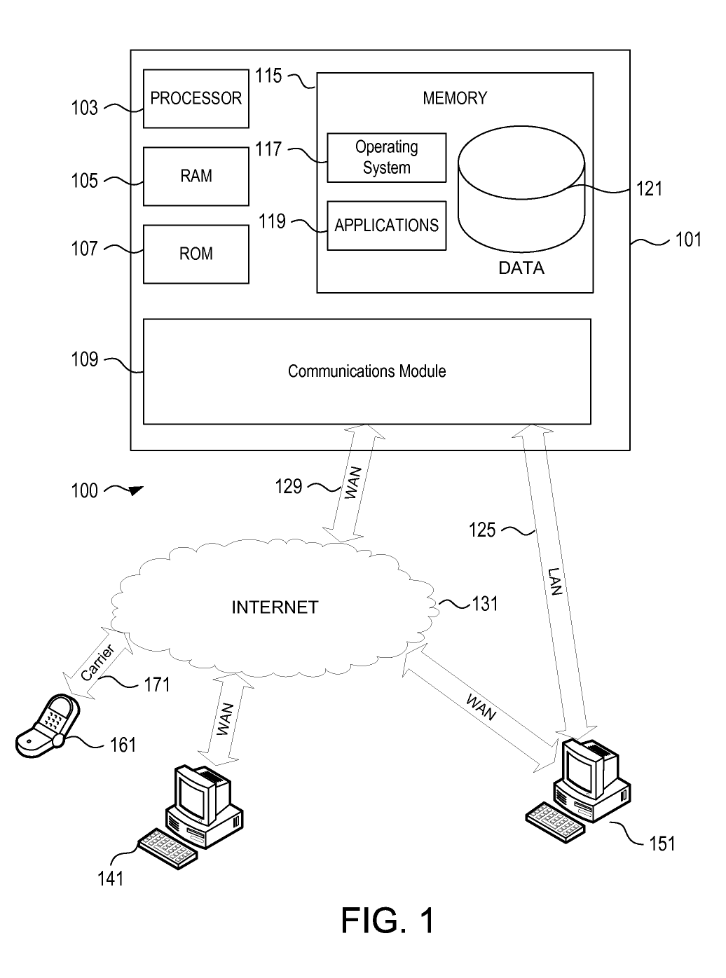

FIG. 1 illustrates an example of a suitable computing system environment 100 that may be used according to one or more illustrative embodiments. The computing system environment 100 is only one example of a suitable computing environment and is not intended to suggest any limitation as to the scope of use or functionality contained in the disclosure. The computing system environment 100 should not be interpreted as having any dependency or requirement relating to any one or combination of components shown in the illustrative computing system environment 100.

The disclosure is operational with numerous other general purpose or special purpose computing system environments or configurations. Examples of well known computing systems, environments, and/or configurations that may be suitable for use with the disclosed embodiments include, but are not limited to, personal computers (PCs), server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

With reference to FIG. 1, the computing system environment 100 may include a computing device 101 wherein the processes discussed herein may be implemented. The computing device 101 may have a processor 103 for controlling overall operation of the computing device 101 and its associated components, including random-access memory (RAM) 105, read-only memory (ROM) 107, communications module 109, and memory 115. Computing device 101 typically includes a variety of computer readable media. Computer readable media may be any available media that may be accessed by computing device 101 and include both volatile and nonvolatile media, removable and non-removable media. By way of example, and not limitation, computer readable media may comprise a combination of computer storage media and communication media.

Computer storage media include volatile and nonvolatile, removable and non-removable media implemented in any method or technology for storage of information such as computer readable instructions, data structures, program modules or other data. Computer storage media include, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by computing device 101.

Communication media typically embodies computer readable instructions, data structures, program modules or other data in a modulated data signal such as a carrier wave or other transport mechanism and includes any information delivery media. Modulated data signal includes a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Computing system environment 100 may also include optical scanners (not shown). Exemplary usages include scanning and converting paper documents, e.g., correspondence, receipts, etc. to digital files.

Although not shown, RAM 105 may include one or more are applications representing the application data stored in RAM 105 while the computing device is on and corresponding software applications (e.g., software tasks), are running on the computing device 101.

Communications module 109 may include a microphone, keypad, touch screen, and/or stylus through which a user of computing device 101 may provide input, and may also include one or more of a speaker for providing audio output and a video display device for providing textual, audiovisual and/or graphical output.

Software may be stored within memory 115 and/or storage to provide instructions to processor 103 for enabling computing device 101 to perform various functions. For example, memory 115 may store software used by the computing device 101, such as an operating system 117, application programs 119, and an associated database 121. Also, some or all of the computer executable instructions for computing device 101 may be embodied in hardware or firmware.

Computing device 101 may operate in a networked environment supporting connections to one or more remote computing devices, such as computing devices 141, 151, and 161. The computing devices 141, 151, and 161 may be personal computing devices or servers that include many or all of the elements described above relative to the computing device 101. Computing device 161 may be a mobile device communicating over wireless carrier channel 171.

The network connections depicted in FIG. 1 include a local area network (LAN) 125 and a wide area network (WAN) 129, but may also include other networks. When used in a LAN networking environment, computing device 101 may be connected to the LAN 825 through a network interface or adapter in the communications module 109. When used in a WAN networking environment, the computing device 101 may include a modem in the communications module 109 or other means for establishing communications over the WAN 129, such as the Internet 131 or other type of computer network. It will be appreciated that the network connections shown are illustrative and other means of establishing a communications link between the computing devices may be used. Various well-known protocols such as TCP/IP, Ethernet, FTP, HTTP and the like may be used, and the system can be operated in a client-server configuration to permit a user to retrieve web pages from a web-based server. Any of various conventional web browsers can be used to display and manipulate data on web pages.

Additionally, one or more application programs 119 used by the computing device 101, according to an illustrative embodiment, may include computer executable instructions for invoking user functionality related to communication including, for example, email, short message service (SMS), and voice input and speech recognition applications.

Embodiments of the disclosure may include forms of computer-readable media. Computer-readable media include any available media that can be accessed by a computing device 101. Computer-readable media may comprise storage media and communication media and in some examples may be non-transitory. Storage media include volatile and nonvolatile, removable and non-removable media implemented in any method or technology for storage of information such as computer-readable instructions, object code, data structures, program modules, or other data. Communication media include any information delivery media and typically embody data in a modulated data signal such as a carrier wave or other transport mechanism.

Although not required, various aspects described herein may be embodied as a method, a data processing system, or as a computer-readable medium storing computer-executable instructions. For example, a computer-readable medium storing instructions to cause a processor to perform steps of a method in accordance with aspects of the disclosed embodiments is contemplated. For example, aspects of the method steps disclosed herein may be executed on a processor on a computing device 101. Such a processor may execute computer-executable instructions stored on a computer-readable medium.

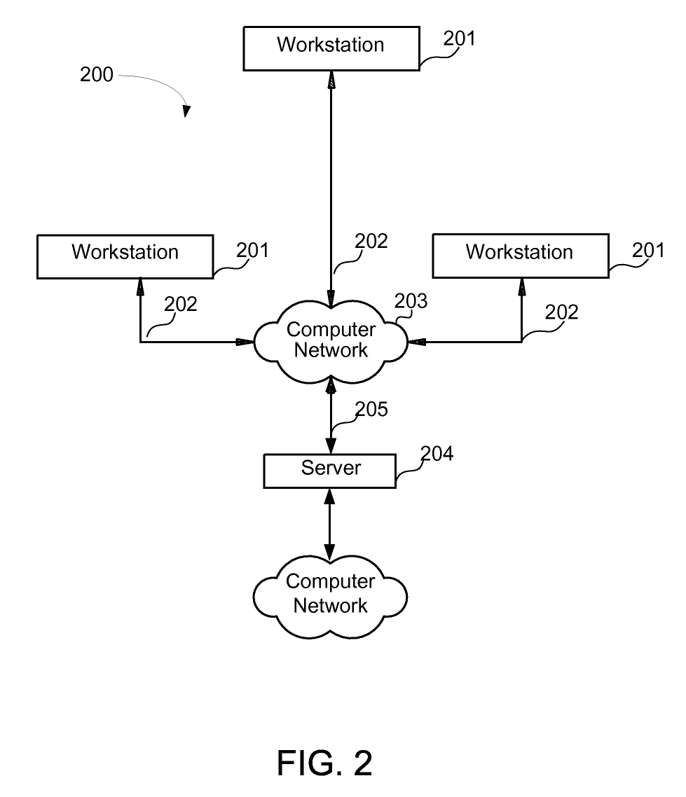

Referring to FIG. 2, an illustrative system 200 for implementing example embodiments according to the present disclosure is shown. As illustrated, system 200 may include one or more workstation computers 201. Workstations 201 may be local or remote, and may be connected by one of communications links 202 to computer network 203 that is linked via communications links 205 to server 204. In system 200, server 204 may be any suitable server, processor, computer, or data processing device, or combination of the same. Server 204 may be used to process the instructions received from, and the transactions entered into by, one or more participants.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, hard-wired links, etc.

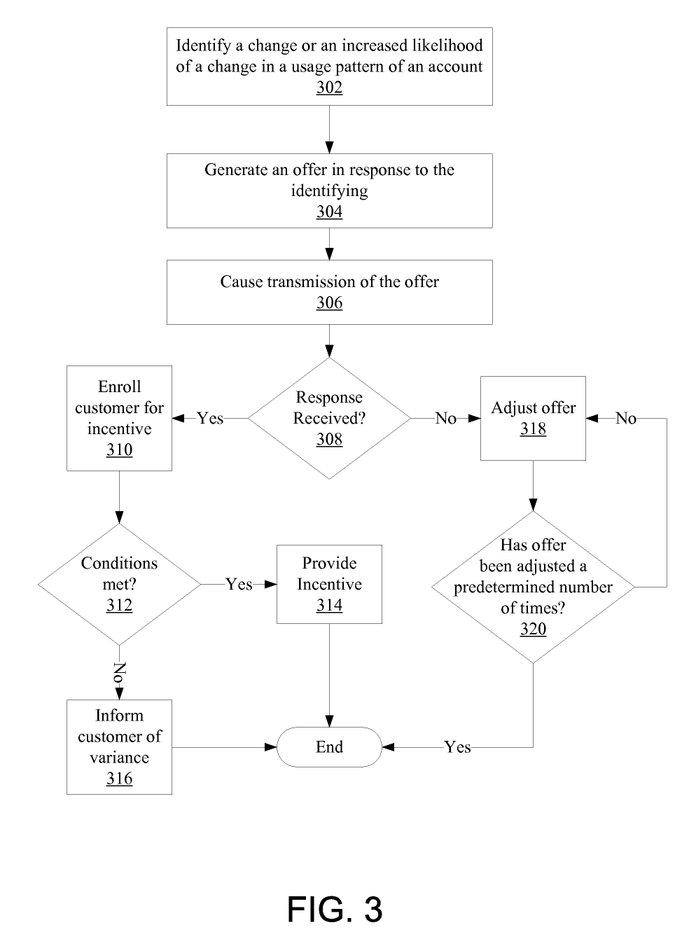

The steps that follow in FIG. 3 may be implemented by one or more of the components in FIGS. 1 and 2 and/or other components, including other computing devices.

The example embodiments provide for monitoring of data to mitigate customer attrition based on identifying a change or an increased likelihood of a change in a usage pattern of an account. For example, a financial institution, such as a bank, credit union, retailer, etc. may provide a customer with an account. Other types of entities may also be an account provider. Example accounts may be a credit card account, a revolving account, or other types of accounts. The change in the usage pattern may suggest that there is a certain likelihood that the customer may be considering closing the account or using some other account as their primary account. Example changes may be a reduction in a spending and/or redemption of a predetermined number of rewards points. The example embodiments may also monitor to predict that there is an increased likelihood that certain customers may change the usage pattern of their account. Identifying a change or predicting that there is an increased likelihood of a change in usage pattern may trigger providing an offer to the customer with an incentive for continued use of the account for future transactions.

FIG. 3 illustrates an example flow diagram of a method for monitoring of activity to mitigate account attrition. The method may be implemented by the computing device 101 or other computer. The computing device 101 may be associated with a financial institution or other entity that provides an account to a customer. The order of the blocks depicted in FIG. 3 may be rearranged, one or more blocks may be repeated in sequential and/or non-sequential order, and/or one or more blocks may be omitted. Further, other blocks may be added to the flow diagram. The method may begin at block 302.

In block 302, the method may include processing data to identify a change or an increased likelihood of a change in a usage pattern for an account. In an example, the computing device 101 may include a database or other memory storing account data for each of its customers. Account data may include information on one or more of a credit limit for the account, purchases made during a time interval (e.g., last month) or since opening of the account, cash advances, loans, credits, payments or other usages of the account, as well as other types of information. Account data may also include information on incentives (e.g., reward points) earned by the customer for use of the account.

The computing device 101 may process the account data to identify a change in a particular customer's usage pattern of the account. Changes may be based on, for example, identifying an adjustment (e.g., increase, decrease) of a particular usage metric in how a customer uses the account, and/or based on identifying redemption of account incentives. Usage metrics are further described below, and may include, for example, changes in amount spent. The computing device 101 may consider particular usage metrics individually, or in combination, to determine whether there has been a change or increased likelihood of a change in usage pattern of an account, as described in further detail below.

In an example, the computing device 101 may process the account data to identify spending habits of the customer, and to identify adjustments to the spending habits over time. The computing device 101 may look for changes in spending habits by comparing account activity in one time interval to another. For example, the computing device 101 may compare spending in consecutive time intervals (e.g., compare last month's spending to this month's spending) and/or in non-consecutive time intervals (e.g., compare spending in January of last year to January of this year) to determine whether there has been a change. The computing device 101 may also compare spending in one time interval to average historical spending. For example, the computing device 101 may compare average monthly spending over the last 6 months to spending in a current month, and/or may compare spending in a current month of this year to spending of the same month in the previous year. The computing device 101 may determine whether spending has changed by a certain amount (e.g., increased by a certain percentage, decreased by a certain percentage). The computing device 101 may also identify other types of changes instead of or in addition to spending, including, for example, comparing, from one time interval to another, a total number of transactions, changes in merchants where the customer shops, and the like.

The computing device 101 may set predetermined spending thresholds to determine when there has been a change in a usage pattern based on a spending usage metric. For example, the computing device 101 may process account data to identify whether there has been more than a 25% month to month spending change (e.g., between January and February), and/or a 35% year to year spending change for a particular month (e.g., between January of last year and January of this year). If so, the computing device 101 may identify a change in usage pattern of the account. Other percentage changes and time intervals of other lengths may also be used.

In another example, the computing device 101 may process the account data to identify a change based on determining that a balance of the account has been reduced below a predetermined level. The balance may be a new balance for a current time interval, and/or may be a combination of new balance for the current time interval and existing balance from one or more prior time intervals. The predetermined level may be a certain dollar amount, a percentage of a credit limit associated with the account, a percentage of average balance over a time interval (e.g., average monthly account balance over last 6 months), and/or a percentage of average purchases over a time interval (e.g., average monthly purchase amount over 12 months). Further, the computing device 101 may process the account data to identify a change based on determining that at least a portion of a balance of the account has been transferred to another account provider.

Also, the computing device 101 may determine that a total amount of purchases using the account over a predetermined time interval has declined below a predetermined level. For example, the computing device 101 may process the account data to determine total expenditures over a 6 month period using the account, and may identify a change if the total falls below a predetermined level.

In another example, the computing device 101 may process the account data to identify a change in usage pattern based on whether transactions are conducted with a particular merchant or provider. For instance, the computing device 101 may process the account data to identify one or more merchants or providers that the customer has historically conducted transactions with using the account. In an example, the customer may have historically paid their electric bill from the electric company using the account. The computing device 101 may identify a change based on processing the account data to determine that the customer has not paid the merchant or provider using the account for a predetermined time interval, and is not using the account to pay for a similar service/product from an equivalent merchant or provider within the predetermined time interval.

In another example, the computing device 101 may identify a change in account usage pattern in response to detecting that a customer has redeemed an incentive associated with the account. For instance, the customer may accrue rewards points based on making purchases or other activity associated with the account (e.g., opening another account with a financial institution that provides the account, shopping a particular merchants, etc.). The computing device 101 may process the account data to determine that a predetermined amount of rewards points have been redeemed. The predetermined number may be a specific number of rewards points or may be a particular percentage of the total number of rewards points accrued. For example, the computing device 101 may identify a change in an account usage pattern when a customer redeems 25% or more of their accrued rewards points.

Further, the computing device 101 may process the account data to identify a change based on redemption of rewards points in combination with a decline in transaction activity after a date of redemption. For example, the computing device 101 may identify a change in usage pattern if a customer redeems at least a certain percentage (e.g., 50% or more) of accrued rewards points and new transaction activity (e.g., new purchases) using the account during a time period subsequent to redemption of the rewards points (e.g., in the two months after redemption) is less than a predetermined level and/or differs by a certain percentage as compared to a previous time interval.

In a further example, the computing device 101 may process the account data to identify a change in account usage pattern based on determining a reduction of cash in-flow to the account and/or an increase in debt. For example, the account may be a debit account where the customer's paycheck is direct deposited at periodic time intervals. The computing device 101 may identify a change by processing the account data to determine that a paycheck was not deposited when expected (e.g., first of the month).

The computing device 101 may also identify changes in a usage pattern based on monitoring a customer's credit activity via a credit bureau. The computing device 101 may obtain a credit report on a customer identifying the amount and different providers of credit to the customer. The computing device 101 may identify a change in a usage pattern by monitoring for opening and/or closing of accounts. For example, the computing device 101 may determine that a customer has recently opened a new account with a competitor of the account provider, to identify a change in a usage pattern.

Further, the computing device 101 may periodically monitor a balance of a competitive account carried by the customer over time based on information obtained from the credit bureau. The computing device 101 may monitor for changes in the competitive account balance (e.g., above a threshold) to determine if the customer is increasingly using the competitive account, to identify a change in a usage pattern. Also, the computing device 101 may monitor cash outflow to a competitor (e.g., balance transfer, wire transfer, etc.) to identify a change in a usage pattern. Thus, the computing device 101 may consider the customer's usage of competing accounts when identifying changes in a usage pattern.

The computing device 101 may monitor social media and/or searches via online search engines to identify a change in a usage pattern of an account and/or for an increased likelihood of a change in the usage pattern. For instance, the computing device 101 may monitor a social networking website associated with the customer (e.g., a FACEBOOK® account). The computing device 101 may monitor for comments posted by the customer or by users in the customer's social network (e.g., “friends” of the customer) expressing dissatisfaction with the financial institution or with the customer's account. Comments, for example, may be posted on a blog, via TWITTER®, or in other manners online. The computing device 101 may identifying an increased likelihood of a change in a usage pattern based on identifying a customer expressing dissatisfaction.

The computing device 101 may also monitor for trending of terms in social networks and/or search engines to identifying an increased likelihood of a change in a usage pattern. For example, the computing device 101 may determine that many users, including non-customers, are discussing via a social networking website, posting comments about, and/or are conducting a predetermined threshold level of searches for a competing account and/or product. Such activity may be used to predict that an existing customer and/or a group of existing customers may be considering migrating to the competing account and/or product. In an example, users of a social networking website and/or search engine may be discussing or searching on a new competing product (e.g., new credit card that supposedly awards more frequent flier miles than other cards). The computing device 101 may determine a segment of the financial institution's customers who may be interested in the competing product, based on similar interests (e.g., customers who frequently travel via airplane), to predict that there is or may be a change in usage activity for that segment of customers.

The computing device 101 may identify a change in a usage pattern and/or a likelihood of a change by considering usage metrics individually, as described above, or may analyze multiple usage metrics in combination to determine if combined activity is sufficient to identify a change or an increased likelihood of a change in a usage pattern. For example, the computing device 101 may assign a score to each usage metric, may sum all of the assigned scores to determine a total score, and may compare the total score to a score threshold. Based on the threshold comparison, the computing device 101 may determine whether there has been a change in a usage pattern of the account.

The computing device 101 may assign a score within a range of values to each usage metric. Some usage metrics may be considered more important than others, and may have a wider range of values that permits assignment of a larger score than other categories. For example, the computing device 101 may assign a score within a range between 0-10 for a first usage metric, and a score within a range between 0-15 for a second usage metric. Some usage metrics that may be assigned larger scores may be, for example, that a customer has recently redeemed a large reward point balance, no longer is using direct deposit, or there has recently been a transfer of a nominal amount (e.g., $0.01 dollars) to or from the customer's account. In some instances, such events may be indicative that a customer has a higher likelihood of closing their account and usage metrics for those events may be assigned a higher score. In other examples, all usage metrics may be assigned values over the same range.

Example categories of usage metrics may be a spending usage metric, a rewards point redemption usage metric, a balance usage metric, an inflow usage metric, and a social media usage metric. The computing device 101 may process account activity and analyze social media to assign a score to each usage metric. When assigning a score, the computing device 101 may identify information relevant to each of the usage metrics.

For a spending habit usage metric, for example, the computing device 101 may compare a customer's spending habits in one time interval to spending habits in another interval. If spending changes by greater than a predetermined percentage, the computing device 101 assign a first value for the score (e.g., 25), and, if less than the predetermined percentage, may assigned a second value for the score (e.g., 0). A category may also be associated with multiple thresholds with a particular value associated with each threshold (e.g., score of 0 if less than a first predetermined percentage, score of 15 if greater than the first predetermined percentage but less than a second predetermined percentage, and a score of 25 if greater than the second predetermined percentage). One or more thresholds may also be used for the rewards point redemption usage metric, the balance usage metric, and the inflow usage metric, as well as other usage metrics, to determine a score for each usage metric. Other usage metrics may also be used.

Once scores have been determined for each usage metric, the computing device 101 may sum the scores to determine a total score. A weighting may or might not be applied to each usage metric. For example, the sum may be a weighted sum where a score associated with each usage metric is multiplied by a weighting factor, and then the weighted scores are summed. For example, the spending habits usage metric may have a weighting factor of 1.5, the rewards point redemption usage metric may have a weighting factor of 1.0, the balance usage metric may have a weighting factor of 0.5, and the inflow usage metric may have a weighting factor of 0.75. The computing device 101 may compare the total score to a score threshold to determine whether a change in usage pattern of the account has been identified. If equal to or greater than the threshold, the computing device 101 may identify a change and, if below, the computing device 101 may determine that there is no change. Referring again to FIG. 3, the method may proceed from block 302 to block 304.

In block 304, the method may include generating an offer in response to the identifying. The identification of a change or increased likelihood of a change, based on either identifying a change in a single or multiple usage metrics, may trigger the computing device 101 to generate an offer to incentivize the customer to continue using the account for future transactions. Example incentives may be bonus rewards points, more cash back on purchases, additional frequent flier miles, access to an event (e.g., concert, festival, sporting competition, etc.), a reduction in the number of rewards points required to obtain a product/service, or other types of incentives.

The generating of the offer may also be in response to monitoring social media and/or online searches corresponding to a competing product, and determining that the customer's account is associated with a customer having a characteristic targeted by the competing product. For example, the competing product may be a credit card with a rewards program offering free and/or discounted stays at hotels. Users may be searching on the competing product and/or may be discussing the competing product online via various types of social media (e.g., message boards, blogs, etc.). If at least a threshold amount of comments and/or searches are identified (e.g., combination of 30,000 posts and searches, which may or may not be unique), the computing device 101 may identify a segment of its customers that have a characteristic targeted by the competing product. For example, the computing device 101 may identify customers who frequently stay at hotels and send those customers an offer.

The generated offer may be determined based on the customer and the customer's interests. To select which offer to send to a customer, the computing device 101 may categorize the customer into a particular one of a plurality of categories. Categories may be based on one or more of demographic information, geographic location, education level, occupation, income level, personal network of the customer, and/or spending history (e.g., average spending over a time interval). A personal network of the customer may identify other individuals that are acquaintances of and/or likely to be acquaintances of the customer. The other individuals may or might not be customers of the account provider. The computing device 101 may determine the personal network based on information provided by the customer and/or based on information obtained from one or more social networking websites. For example, the computing device 101 may access a social networking website to identify other individuals the customer has identified as their acquaintances, such as, for example, FACEBOOK® friends. The computing device 101 may also process account data of multiple customers to identify purchases at a same merchant at similar times, to infer that one customer knows another (e.g., purchases by multiple customers at a same golf course on the same days over the summer).

Customers may be included in a particular category based on profitability to the financial institution. For example, there may be a high priority customer category, a middle priority customer category, and a value customer category. Each category may be associated with an incentive term for an offer. For example, an offer may include a multiplier for rewards points on some or all future transactions within a time period (e.g., over the next two months). A value of the multiplier may be based on the customer category. For example, the value of the multiplier may be 1.5 for high priority customers, 1.25 for middle priority customers, and 1.1 for value customers. Further, some offers may only be for customers in certain categories, but not in other categories. For example, some offers may specifically target customers in the value customer category, but not in the other categories.

Within a particular category, the computing device 101 may determine which of available offers to provide to a customer. For example, a financial institution may have available offers for increasing rewards points, travel rewards, increasing cash back, or other incentives. The computing device 101 may process the account data to determine which of the available offers to provide to the customer. For example, the computing device 101 may determine that the customer travels frequently based on the account data, and may select an offer for travel rewards.

The offer may also specify one or more conditions for accepting the offer. Conditions may require that the customer use the account in future transactions over a certain time period and/or for a predetermined number of transactions, as well as may require that the customer spend at least a minimum amount using the account. Other account use requirements may also be specified. For example, an offer condition may require the customer to spend at least $X each month for the next three months. In another example, an offer condition may require that the customer make at least one purchase at a particular merchant per month for the next two months. Referring again to FIG. 3, the method may proceed from block 304 to block 306.

In block 306, the method may include causing transmission of the offer to the customer. The computing device 101 may electronically send the offer to a computer (or other device) of the customer. Also, the computing device 101 may cause the offer to be physically sent via a mail service.

In block 308, the method may include determining whether a response to the offer has been received. If a response accepting the offer is received, the method may proceed to block 310. In block 310, the method may include enrolling the customer for the incentive provided in the offer. For example, the computing device 101 may update the account data associated with the customer to reflect that the customer accepted the offer.

In block 312, the method may include determining whether the customer has complied with any incentive conditions associated with the offer. The incentive conditions may be based on usage of the account for future transactions. Example incentive conditions may specify a time interval and require a predetermined number of transactions, an aggregate amount of purchases, or other types of account usage during the time interval. If some or all of the conditions are met, the method may proceed to block 314 where the incentive is provided to the user. For example, the computing device 101 may distribute additional rewards points to the customer's account, may distribute additional frequent flier miles, may award an additional cash back bonus, and the like.

Referring again to block 312, if one or more of the conditions are not met, the method may include informing the customer of the variance. For example, the computing device 101 may inform the customer of which one or more of the conditions were not met, and what the customer can do to meet the one or more incentive conditions. If the customer adjusts account usage as recommended, the computing device 101 may cause the incentive to be provided to the customer. Otherwise, the incentive is not provided.

Referring again to block 308, if a response is not received or if a customer does not accept an offer, the method may proceed to block 318. In block 318, the method may include adjusting the offer and communicating a new offer to the customer. For example, the computing device 101 may determine whether a customer accepts an offer within a predetermined time interval. If not, the computing device 101 may adjust the offer. The computing device 101 may adjust offers for all categories of customers, or for only some of the categories. The adjustment may be to improve the incentive originally included in the offer (e.g., an even greater number of bonus points), to add an additional incentive, to replace the original incentive with a different incentive, etc. The computing device 101 may then communicate a new offer with an adjusted incentive to the customer.

If the customer continues not to respond, in block 320, the method may include determining whether the offer has been adjusted a predetermined number of times. For example, the computing device 101 may continue to adjust the incentives included in each offer until the customer accepts one of the offers, until a predetermined number of adjusted offers have been sent, or until a customer voluntarily increases usage of the account. Each adjusted offer may include improved incentive terms compared with previous offers, and/or may include a different incentive or combination of incentives. If the customer does not accept any of the offers after the predetermined number of adjustments, the computing device 101 may stop sending new offers. The computing device 101 may also stop providing incentives if the customer requests to no longer receive the offers or after a predetermined amount of time. The method of FIG. 3 may end, and/or may return to any of the preceding blocks.

Aspects of the embodiments have been described in terms of illustrative embodiments thereof. Numerous other embodiments, modifications and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the embodiments. They may determine that the requirements should be applied to third party service providers (e.g., those that maintain records on behalf of the company).

1. An apparatus comprising:
at least one processor; and
at least one memory storing computer executable instructions that, when executed, cause the apparatus at least to:
identify a change or an increased likelihood of a change in a usage pattern of an account;
generate an offer in response to the identifying, the offer comprising an incentive for use of the account in future transactions; and
cause transmission of the offer.

2. The apparatus of claim 1, wherein the change is identified based on determining that a balance of the account has been reduced below a predetermined level.

3. The apparatus of claim 2, wherein the predetermined level is a percentage of an available amount of credit.

4. The apparatus of claim 1, wherein the change is identified based on determining that the account has not been used for a transaction at a merchant or provider in a predetermined amount of time.

5. The apparatus of claim 1, wherein the change is identified based on determining that an average amount of purchases using the account over a predetermined amount of time has declined below a threshold level.

6. The apparatus of claim 1, wherein the change is identified based on determining at least a portion of a balance of the account has been transferred to another account provider.

7. The apparatus of claim 1, wherein the change is identified based on determining that at least a predetermined amount of rewards points associated with the account have been redeemed.

8. The apparatus of claim 1, wherein the change is identified based on determining that at least a predetermined amount of rewards points associated with the account have been redeemed and new transaction activity using the account has declined in a predetermined time period subsequent to redemption of the at least a predetermined amount of rewards points.

9. The apparatus of claim 1, wherein the computer executable instructions, when executed, further cause the apparatus to categorize a customer into a particular one of a plurality of customer categories, wherein the offer is further based on the particular customer category.

10. The apparatus of claim 9, wherein the categorizing is based on personal network information identifying one or more other customers with which the customer has or is likely to have a relationship.

11. The apparatus of claim 10, wherein the personal network information is based on information obtain a social network website.

12. The apparatus of claim 1, wherein the offer comprises an account use requirement over a predetermined time interval.

13. The apparatus of claim 1, wherein the computer executable instructions, when executed, further cause the apparatus to identify continued reduced usage of the account and generate a second offer with an offer term that differs from an offer term of the offer.

14. The apparatus of claim 1, wherein the offer adjusts a number of rewards points required to obtain a product and/or service.

15. The apparatus of claim 1, wherein the generating of the offer is further in response to:
monitoring social media and/or online searches corresponding to a competing product; and
determining that the account is associated with a customer having a characteristic targeted by the competing product.

16. A method comprising:
identifying, by a processor, a change or an increased likelihood of a change in a usage pattern of an account;
generating an offer in response to the identifying, the offer comprising an incentive for use of the account in future transactions; and
causing transmission of the offer.

17. The method of claim 16, further comprising categorizing a customer into a particular one of a plurality of customer categories, wherein the offer is based on the particular customer category.

18. The method of claim 17, wherein the categorizing is based on personal network information identifying one or more other customers with which the customer has or is likely to have a relationship.

19. The method of claim 16, further comprising identifying continued reduced usage of the account and generating a second offer with an offer term that differs from an offer term of the offer.

20. The method of claim 16, wherein the generating of the offer is further in response to:
monitoring social media and/or online searches corresponding to a competing product; and
determining that the account is associated with a customer having a characteristic targeted by the competing product.

21. A non-transitory computer-readable storage medium storing computer-executable instructions that, when executed, cause an apparatus at least to perform:
identifying a change or an increased likelihood of a change in a usage pattern of an account;
generating an offer in response to the identifying, the offer comprising an incentive for use of the account in future transactions; and
causing transmission of the offer.

22. The non-transitory computer-readable storage medium of claim 21, wherein the computer executable instructions, when executed, further cause the apparatus to categorize a customer into a particular one of a plurality of customer categories, wherein the offer is based on the particular customer category.

23. The non-transitory computer-readable storage medium of claim 22, wherein the categorizing is based on customer network information identifying one or more other customers with which the customer has or is likely to have a relationship.

24. The computer-readable storage medium of claim 21, wherein the computer executable instructions, when executed, further cause the apparatus to identify continued reduced usage of the account and generate a second offer with an offer term that differs from an offer term of the offer.

25. The computer-readable storage medium of claim 21, wherein the generating of the offer is further in response to:
monitoring social media and/or online searches corresponding to a competing product; and
determining that the account is associated with a customer having a characteristic targeted by the competing product.
